(19) United States
(12) Patent Application Publication
(10) Pub. No.: US 2006/0015733 A1
(43) Pub. Date: Jan. 19, 2006

(54) Process and system for the material reduction of counterfeit and identity-maker fraud

(75) Inventors: John E. O'Malley, Winter Park, FL (US); Scott A. Hansen, Sanford, FL (US); Helen A. Beckel, Oak Grove, OR (US); Samuel R. Kilmer, Nobelsville, IN (US); John A. Watson II, Loganville, GA (US); Clifford A. Ludwick JR., Loganville, GA (US)

Correspondence Address: DICKSTEIN SHAPIRO MORIN & OSHINSKY LLP, 2101 L Street, NW, Washington, DC, 20037, US

(73) Assignee: John H. Harland Company

(21) Appl. No.: 11/148,255

(22) Filed: Jun. 9, 2005

Related U.S. Application Data
(60) Provisional application No. 60/582,083, filed on Jun. 24, 2004.

(51) Int. Cl. H04L 9/00

(52) U.S. Cl. 713/176

(57) ABSTRACT

A method, system and product for the material reduction of counterfeit and identity/maker fraud as it relates to payment vehicles and other authentication-requiring documents. The authentication system allows an institution to apply a code comprising relevant elements of an end-user to an authentication-requiring document. The authentication system allows institutions to validate the authentication-requiring documents at the point of presentment. The authentication system is stand alone and self-authenticating, allowing institutions to include the method, system and product anywhere in the institutions' document verification or manufacturing process.

### CROSS-REFERENCE TO RELATED APPLICATIONS

This application claims priority to provisional application No. 60/582,083, filed Jun. 24, 2004, the subject matter of which is incorporated by reference herein.

### BACKGROUND

The invention relates to methods and systems for the material reduction of counterfeit and identity/maker fraud as it relates to payment instruments, e.g., financial documents, checks, and other authentication-requiring documents.

The escalation of fraud and losses pertaining to fraud is a huge social and economic issue today. It is estimated that annual losses due to forgery approach several billions of dollars per year and that technological advancements in electronic payments will contribute further to increased fraud and losses from fraud. While there are current fraud prevention techniques, these techniques will not survive the advancement in technology because they focus on conventional paper and printing safeguards. Fraud prevention techniques must address new technological advancements to reduce the impact of fraud and losses attributed to fraud.

For example, one type of paper payment instrument is a paper check. Check fraud relates to about half of the annual forgery amount. There are multiple types of check fraud that exist today, including NSF (non-sufficient-funds), kiting (a form of fraud that involves drawing out money from one bank account that does not have sufficient funds to cover the check drawn from another account), counterfeiting, identity fraud, and forgery. It is expected that NSF and kiting will drop as the float on paper checks continues to shorten because of image exchange and settlement, and the conversion of paper checks to electronic forms of payments. As image exchange, check conversion, and check truncation become adopted, new fraud risks will surface. As such, check fraud is expected to escalate.

One anticipated fraud risk relates to the legislative enactment of the “Check 21” Act. Check 21 provides many things including the right, but not the requirement, to convert a paper check into an image replacement document (IRD) at any point in the clearing process. This substitute check is the legal equivalent of the original paper check. The legislation includes a requirement that the converting entity or financial institution (often the bank of first presentment) provide a 60-day warranty that the converted check was not a duplicate, and that the check was free of defects. Defects are understood to include alterations and counterfeits. While Check 21 will significantly speed up the handling and collection of checks, the potential for enormous un-prosecutable check fraud losses is expected, as the conversion process destroys the evidence of fraud in most cases. For instance, truncation and destruction of checks at the point of sale eliminate most physical forensic evidence traditionally used to track and apprehend criminals, as these items are not image-survivable (paper stock, fingerprints, ink characteristics, and other trace physical evidence). Destruction of evidence is one of the risks that institutions, such as banks and merchants, and end-users will have to endure with the implementation of Check 21.

The risks relating to the conversion of paper checks to IRD is an example of why current fraud prevention techniques will no longer suffice to help reduce counterfeit and identity fraud as it relates to checks, other types of payment vehicles, and other authentication-requiring documents. These fraud prevention techniques focus on conventional paper and printing safeguards, which are not image-survivable. Four examples of check fraud detection are verifying the color, verifying the perforations, verifying the Magnetic Ink Character Recognition (MICR) line, and verifying the bank routing numbers.

Regarding color, by fanning through a group of returned checks, a counterfeit may stand out as having a slightly different color than the rest of the checks in the batch. Regarding perforations, most checks produced by a legitimate printer are perforated and have at least one rough edge. However, many companies now use in-house laser printers with MICR capabilities to generate their own checks from blank stock. These checks may have a micro-perforated edge that is difficult to detect.

In reference to the MICR line, most forgers lack the ability to encode with magnetic ink the bank and customer account information on the bottom of a check. They will often substitute regular toner or ink for magnetic ink, which is dull and non-reflective. Real magnetic ink applied by laser printers is the exception and may have a shine or gloss. If a counterfeit MICR line is printed or altered with non-magnetic ink, the banks sorting equipment will be unable to read the MICR line, which causes the item to be initially rejected. Unfortunately, the bank will typically apply a new magnetic strip and process the check. This works to the forger's advantage because it takes additional time to process the fraudulent check. In addition, banks cannot treat every initially rejected MICR check as a fraudulent item because millions of legitimate checks are rejected each day due to unreadable MICR lines.

The nine-digit number between the colon brackets on the bottom of a check is the routing number of the bank on which the check is drawn. The first two digits indicate which of the Federal Reserve Districts the bank is located. It is important that these digits be compared to the location of the bank because a forger will sometimes change these two digits in the routing number in an effort to buy more time to avoid early detection.

The four fraud prevention techniques mentioned above are examples of why the invention is beneficial to documents converted to images. As explained, current fraud detection techniques rely on the document being in paper form, and they are applied after the fraudulent act has been completed. Moreover, they are not applicable once the document has been converted to an IRD and then destroyed. Fraud prevention techniques must be capable of distinguishing an alteration or counterfeit from an original item during the digitization process. The risk of destroying evidence suggests that fraud prevention at the point of presentment is even more important than fraud detection after the fact. Fraud prevention techniques, therefore, must be image-survivable in order to detect fraud, e.g., forged signature on a check, at the time the document is presented and digitized. However, such techniques must also be secure, so that the true signature is not obtainable or observable, even when being compared to the scripted signature that appears on the document.

U.S. patent application publication no. 2003/0115470 A1 (Cousins et al.) discloses a check validation technique wherein a payor's signature is digitized, encrypted and embedded on the front of a check using glyphs. When the check is presented for payment, a clerk using a decoding device, decodes and decrypts the digitized signature such that a human-readable image of the digitized signature can be seen on a screen for comparison with the payor's scripted signature. It is desirable, however, that the digitized version of the payor's complete signature be encoded such that the true representation of the signature cannot be reproduced even when the document is presented for authentication.

U.S. patent application publication nos. 2004/0075869 A1 (Hilton et al.), 2004/0234117 A1 (Tibor), and 2002/0184152 A1 (Martin et al.); and U.S. Pat. No. 6,073,121 (Ramzy), U.S. Pat. No. 6,390,362 (Martin), U.S. Pat. No. 6,170,744 (Lee et al) and U.S. Pat. No. 6,728,397 B2 (McNeil) also disclose encoding authenticating information on the face of an authentication-requiring document. These techniques, however, do not encode the authentication component (e.g., payor's/presentor's signature) in a manner such that the true representation of the authentication component cannot be reproduced even when the document is presented for authentication.

### SUMMARY

The invention provides a method and system for capturing relevant elements (e.g., signature, biometrics, or account data) from payment vehicles (e.g. checks) and other authentication-requiring documents.

The invention also provides a method and system for translating the relevant elements for an end-user into characteristic components converted to a secure identity code and translating the encrypted secure identity code into a validation symbol.

The invention further provides a method and system integrating an authentication-requiring document with a secure identity code validation symbol.

The invention further provides a method and system for authenticating an authentication-requiring document containing a validation symbol, where the true representation of the image data, contained in the validation symbol, must not be reproduced.

The invention also provides a method and system for implementing an authentication system without reference to data stored in a database which allows validation to occur at any point of presentment so that barriers to adoption of the product by others, including costs, security and data management are removed or substantially reduced. One of the key features of the invention is that it survives imaging because the symbol is readable after the imaging process and the subsequent imaging transmissions. Specific to checks, this means that the physical check does not have to be passed along through the various stages of processing because the image data will suffice. This notably supports the Check 21 act's initiative to replace paper checks with image replacement documents at any point in the clearing process. Imaging can occur both at point of presentment in a retail establishment or at any subsequent point in the image clearing process.

A first method of the invention comprises the steps of scanning said document; detecting relevant elements on said document; detecting validation symbols on said document; extracting encrypted secure identity code stored in the validation symbols; extracting characteristic components from the encrypted secure identity code stored in the validation symbols, wherein said characteristic components cannot be re-created into human readable data forms corresponding to the relevant elements on said document; translating the relevant elements on said document into data forms that correspond with the characteristic components stored in the validation symbols on said document; and determining whether the translated relevant elements on said document correspond with the characteristic components stored in the validation symbols on said document. The method further comprises the step of outputting a confidence rating identifying the results of said determining step.

Another method of the invention comprises creating and maintaining a secure identity code for an end-user comprising the steps of collecting relevant elements from data associated with the end-user; analyzing the collected relevant elements; translating the relevant elements to characteristic components; compressing the characteristic components; and encoding the compressed characteristic components into a secure identity code of approximately 100 bytes in size per end-user.

In another aspect of the invention, a method of creating and maintaining a secure identity code symbol is provided. The method comprises obtaining a secure identity code; encrypting the secure identity code; and converting the encrypted secure identity code to a validation symbol. The method further comprises securely delivering the validation symbol to be placed on an authentication-requiring document, storing the validation symbol in a computer readable storage medium, and associating the validation symbol with the end-user.

In yet another aspect of the invention, a computer readable storage medium contains a computer readable code for operating a computer to perform a method of authenticating an authentication-requiring document with validation symbols. The method comprises the steps of scanning said document; detecting relevant elements on said document; detecting validation symbols on said document; extracting encrypted secure identity code stored in the validation symbols; extracting characteristic components from the encrypted secure identity code stored in the validation symbols, wherein said characteristic components cannot be re-created into human readable data forms corresponding to the relevant elements on said document; translating the relevant elements on said document into data forms that correspond with the characteristic components stored in the validation symbols on said document; and determining whether the translated relevant elements on said document correspond with the characteristic components stored in the validation symbols on said document. The system further comprises means for outputting a confidence rating identifying the results of said determining means.

In a further aspect of the invention, a system for collecting and encoding relevant elements from data associated with an end-user comprising a stand alone data capture encoding computer program is provided. The system comprises means for collecting relevant elements from data associated with the end-user; analyzing the collected relevant elements; translating the relevant elements to characteristic components; compressing the characteristic components; and encoding the compressed characteristic components into a secure identity code of approximately 100 bytes in size per end-user. The system further comprises means for securely exporting the secure identity code to a computer readable storage medium.

Other objects, features and advantages of the invention will become apparent from the following detailed description and drawings of preferred embodiments of the invention.

### BRIEF DESCRIPTION OF THE DRAWINGS

FIG. 1 is a flowchart illustrating an exemplary method of an institution's processing of an end-user's secure identity code.

FIG. 2 is a flowchart illustrating an exemplary method of the process for creating the secure identity code.

FIG. 3 is a flowchart illustrating an exemplary method of the authentication-requiring document ordering process initiated by an end-user or institution.

FIG. 4 is a flowchart illustrating an exemplary method of integrating the validation symbol with an authentication-requiring document.

FIG. 5 is an illustration of a check generated in accordance with an exemplary embodiment of the invention.

FIG. 6 is a flowchart illustrating an exemplary method of authenticating a document at the point of presentment.

FIG. 7 is an illustration of a check integrated with a validation symbol at the point of presentment in accordance with an exemplary embodiment of the invention.

FIG. 8 is a flowchart illustrating an exemplary method of the processing performed by the signature validation engine to authenticate the relevant elements on a document against the relevant elements stored in the validation symbol on the same document.

FIG. 9 is a flowchart illustrating an exemplary method of back office item processing for adopting the signature validation engine of the invention.

FIG. 10 is a flowchart illustrating how the exemplary method illustrated in FIG. 1 may be implemented for a loan application.

FIG. 11 is a flowchart illustrating how the exemplary method illustrated in FIG. 3 may be implemented for a loan application.

FIG. 12 is an illustration of a promissory note generated in accordance with an exemplary embodiment of the invention.

FIG. 13 is a flowchart illustrating how the exemplary method illustrated in FIG. 6 may be implemented for a loan application.

FIG. 14 is an illustration of a promissory note integrated with a validation symbol at the point of presentment in accordance with an exemplary embodiment of the invention.

### DETAILED DESCRIPTION OF PREFERRED EMBODIMENTS

The invention establishes an authentication system that allows institutions to integrate an authentication-requiring document with a secure identity code (SIDC) that assists merchants and institutions in verifying the validity of the authentication-requiring document. The system also provides preventive anti-fraud protection measures for the end-user (e.g., check owner) by allowing merchants and institutions to verify an authentication-requiring document (e.g., a personal check or a bank check) at the point of presentment.

The current anti-fraud processes require the authentication-requiring document to be sent to the originating institution for verification; unfortunately, this verification process will occur after the fraudulent act is completed. The invention, on the other hand, may stand alone and self-authenticate, it is not tethered to databases or external networks, and includes an authentication method without reference to data stored in a database. Therefore, other merchants and institutions can verify, for example, a signature on a document at the time it is presented without being connected to the originating institution's network. The system provides greater protection for the end-user than current fraud prevention measures.

As described above, the authentication system of the invention may stand alone and self-authenticate without reference to data stored in a database; this is beneficial to businesses because it removes or reduces business concerns such as data management, transaction costs, and security risks and management. Current fraud detection methods create business problems due to the volume of authentication-requiring documents that are processed at an institution for verification. For example, a financial institution upon which a check is drawn may not have the resources or capacity to compare the signature on each item with the valid signature on file for the end-user. Because the invention permits the verification process to occur at the point of presentment e.g., at a retail establishment, the authentication-requiring documents processed by the originating financial institution will contain fewer fraudulent documents for that institution to process.

The stand alone and self-authenticating features allow the invention to be adopted and used regardless of where the authentication-requiring document's authenticity is verified, such as, but not limited to, the point of sale in retail operations, branch locations within financial institutions, back-office operations in retail or financial institutions, or item processing facilities. This stand alone and self-authenticating system also reduces the time to process a payment at the point of sale because it is automated and requires no connection to a remote database or comparison with other documents. In addition, the SIDC of the invention can be applied to any authentication-requiring document, including but not limited to, checks, government contracts, or financial loan papers. These advantages will encourage adoption of the invention by others.

The invention is not limited by the conventions of paper or printing safeguards of current anti-fraud processes. Technological developments such as the conversion of check to images at the point of presentment create a new fraud detection problem because they require fraud detection for images, and current fraud detection techniques are designed for paper and printing safeguards (e.g., predominate check fraud detection techniques are for verifying color, MICR, perforation, or routing numbers). As such, one key aspect of the invention is that it is image-survivable because, among other things, the validation symbol becomes part of the authentication-requiring document image. Since the authentication-requiring document image does not degrade as it is retransmitted, the validation symbol is usable throughout the life of the image.

An authentication-requiring document includes any document that requires authentication; it may consist of a payment vehicle (e.g., check or credit card) or other documents for an individual's and/or institution's use. An institution may include all financial institutions such as banks, credit unions, savings and loans, leasing companies, thrifts, mortgage lenders/brokers. It should be appreciated that an “institution” is not limited to financial institutions and may include any entity with documents needing authentication such as governments, educational systems, businesses or corporations to name a few.

Two illustrative examples are presented to describe and illustrate exemplary embodiments of the invention. In the first example, the authentication-requiring document is a check and in the other example the document is a promissory note. It should be appreciated that the following description applies to other authentication-requiring documents and that the invention is not limited to checks or promissory notes.

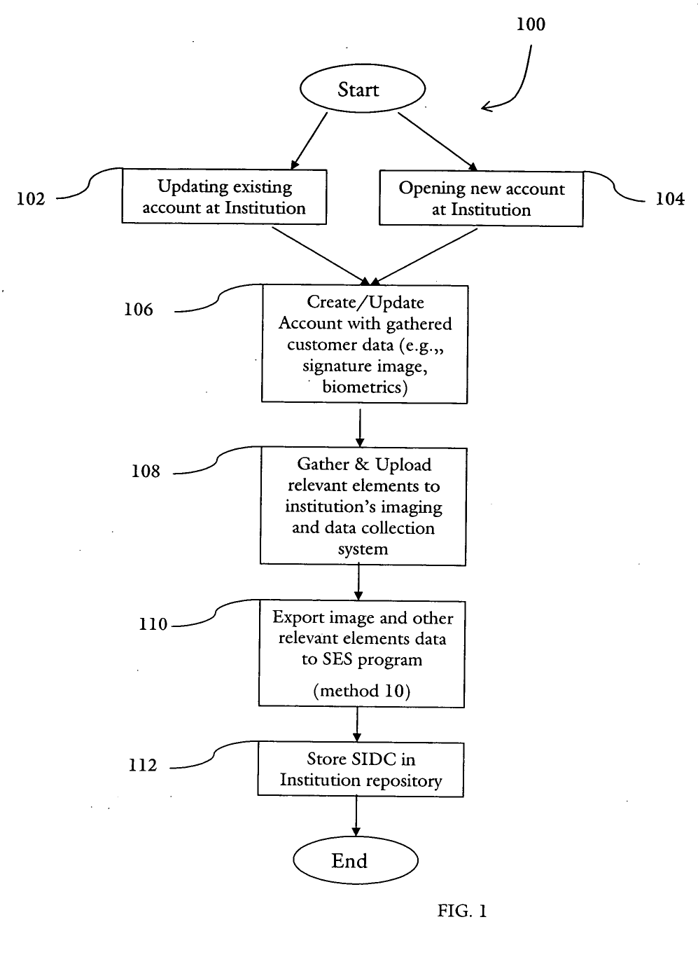

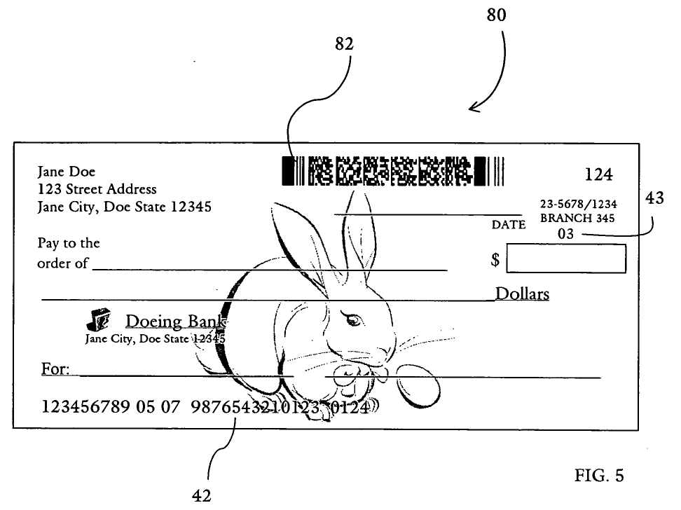

In this first exemplary method, the authentication-requiring documents are checks. FIGS. 1-4 illustrate exemplary methods for an end-user, (e.g., an institution, individual, or business) to receive checks integrated with validation symbol (FIG. 5) in accordance with an embodiment of the invention. Method 100 illustrates an institution's secure identity code creation process. It should be noted that this is one example for creating the secure identity code, and that the illustrated method 100 can be varied in multiple ways to allow an institution to create a secure identity code in a manner convenient for the institution. Method 100 could begin with an end-user opening an account (step 104) or by an end-user updating an existing account (step 102) with an institution, such as a bank. Steps 102 and 104 could occur in many ways, for example, these steps could be accomplished over the Internet or by the end-user visiting the institution.

At step 106, the institution gathers information and data about the account holder as it creates or updates the account information. Examples of information and data include administrative information such as account type, account number, number of signatories; and personal information on the account holders such as signatures, fingerprints, other biometrics, names, addresses, social security numbers, mother's maiden name, drivers license numbers, check style number. What information and data is gathered may be different for different institutions and there is no limit to the type or quantity of information and data that the account holders may be asked to provide. From this information, the institution will select pieces of the information and data to be used uniformly for check validation purposes (referred to herein as “relevant elements”). While each institution could select different relevant elements for check validation, a consistent selection of the same relevant elements facilitates validation of checks at any point in the check processing system, as will be subsequently described. For the purposes of this example, the relevant elements collected for verification purposes are the account holder(s) signature(s), check style, and account number.

As is discussed in more detail below, relevant elements can be translated into secure identity codes (SIDCs) which in turn can be stored in a validation symbol (e.g., a bar code) and printed on an end-user's check. At the point of authentication, however, data for all relevant elements need not be decoded in order to authenticate the end-user's authentication-requiring document. For example, a first comparison could be made with regard to the account number appearing on the check and the account number data residing in the validation symbol, if it fails validation no other data in the validation symbol need to be decoded; i.e., the authentication has failed and no further comparison is needed. A preferred method would be to include relevant elements necessary for authentication, but limits the size of the data stored in the validation symbol.

Joint checking accounts permit more than a single individual to write checks on an account. Likewise, some business accounts require that more than a single individual sign a check in order for the check to be negotiated. Recognizing more than one signature is one of the key features of the invention because the invention permits either a single SIDC to contain data for multiple signatures or multiple SIDCs to be associated with a single account. This feature works by logic commands within the invention which respond to indicators in the validation symbols; and by rules in the signature validation engine which permit authentication based on alternative signatures and based on the correct number of signatures. This feature, for example, allows either a husband or wife to sign checks against a joint account; allows trust account payment to occur only when both the joint trustees authorize payment; and allows any two of multiple officers of a corporation to authorize payment against a corporate account. Each end-user's relevant elements may comprise distinctive or common items of information that will be used during the authentication process. Once the creation or updating of account information at step 106 is complete, the relevant elements are uploaded to the institution's imaging and data collection system (step 108). The invention is not limited to a specific imaging and data collection system; the invention is versatile and can be incorporated with any type of imaging and data collection system having sufficient resolution to capture relevant customer data such as e.g., fingerprint friction-ridge “whorls” or signatures. The imaging and data collection system will utilize industry standard scanning devices having the necessary resolution capacity to translate customer data—in this embodiment, a signature—into data of the desired quality and quantity.

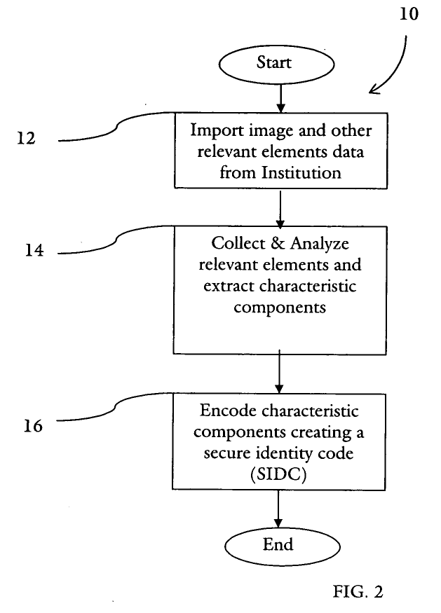

At step 110, the relevant elements data is sent to the signature encoding system (where method 10 of FIG. 2 is executed). Method 10 (FIG. 2) illustrates the processing of the signature encoding system (SES), which in a preferred embodiment is a stand alone encoding computer program. At step 12, the relevant elements data is imported. At step 14, the signature encoding system collects and analyzes the relevant elements data and extracts characteristic components. At step 16, an SIDC is created by encoding the characteristic components translated from the relevant elements. “Encoding” as explained below does not necessarily mean the wholesale conversion of all data in all relevant elements to a different data form.

In the current illustration, the signature encoding system method 10 comprises the encoding of collected relevant elements (e.g., one or more signatures, a check style number, and a bank account number). A key capability of the signature encoding system is the use of an efficient algorithm that translates data extracted from each relevant element into a “characteristic component,” compresses the characteristic components from all relevant elements, and encrypts the characteristic components into a SIDC. Translating into characteristic components in the case of a signature means that the encrypted secure identity code, even if decrypted to reveal the characteristic components, would be insufficient to recreate a facsimile representation of the end-user's signature, which is a significant deterrent to signature forgery; the characteristic components, however, would be sufficient for comparison against similar characteristic components taken from another image or another set of scanning data of the end-user's signature. Compressing characteristic components means that the quantity of data is reduced thus reducing the amount of data to be stored. Encrypting the compressed characteristic components means that the data is translated into a secret code (i.e. cipher text) requiring a key or password to be read as plain text. Reducing the quantity of data in the SIDC supports management of the physical size of the validation symbol placed on the check (discussed below in more detail). In a preferred embodiment, the signature encoding system can reduce the size of the SIDC to approximately 100 bytes per signor. As used herein, characteristic components are defined as unique or identifying properties of an element. In the case of a signature, some examples are: the slant of the lines, the relative size of characters to each other, the number of times a portion of the signature drops below the baseline. Encoding and compressing this data involves assigning numeric ranges to each property and each property is also assigned a weight related to its importance or uniqueness based on statistical variability of the property. Each individual component of the code occupies only a few bits in the overall code. This methodology produces a highly relevant but very small and obscure code.

Referring back to FIG. 1, once the SIDC is created (by method 10), the SIDC is received by a secured method and stored in the institution's repository system (step 112). The secured transmittance method is determined by the institution. As such, the invention is not limited to the form of secured transmittance.

Once the SIDC has been stored in the institution's repository system, it can be integrated with checks associated with the account. Institutions and individuals currently have their own system for obtaining checks without the integration of the SIDC, such as when banks order checks for end-users. The invention can be incorporated into any current check ordering process.

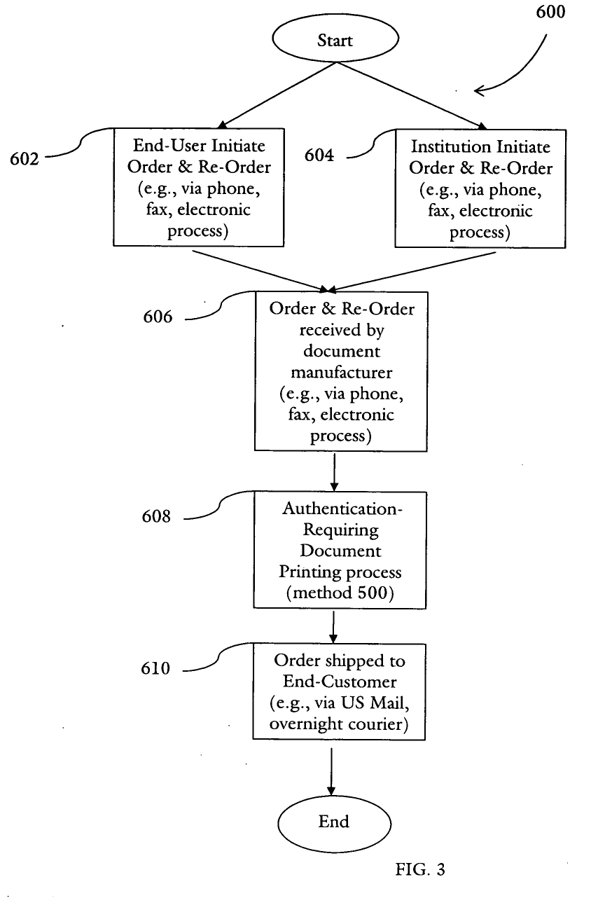

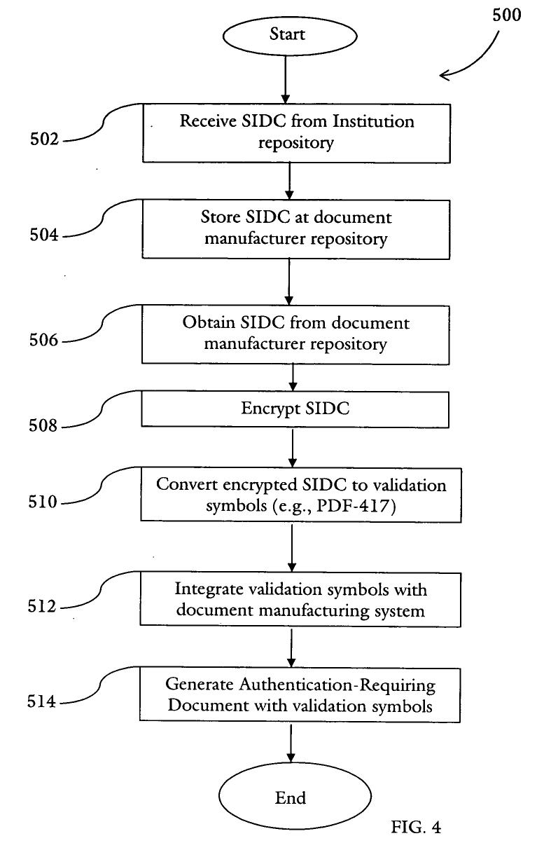

FIG. 3 illustrates one method 600 of ordering checks integrated with one or more SIDCs. Method 600 may begin with the end-user initiating an order or a re-order (step 602). Step 602 can be accomplished by many methods, such as ordering via telephone, facsimile, in person, or an electronic process (i.e., over the Internet). Method 600 may also begin with the institution initiating the order or re-order (step 604), which can also be accomplished by many methods such as ordering via phone, fax, in person, or an electronic process. The check printing vendor receives and processes the order or reorder at step 606. The method continues at step 608 for the authentication-requiring document printing processing (where method 500 of FIG. 4 is executed).

FIG. 4 illustrates an exemplary method 500 of generating a check order that integrates one or more SIDCs. The authentication-requiring document (e.g., a check) generating process comprises converting SIDCs to an evolutionary/alternative symbol (referred to herein as a “validation symbol”), which in the preferred embodiment is a PDF-417 bar code. Method 500 begins at step 502 with the SIDC being retrieved from the institution's repository and delivered to the check printing vendor. Initiating the retrieval and delivery can occur in a variety of ways. For example, the SIDC delivery to the vendor can be initiated with a deposit of each SIDC into the institution's repository system; with a timed daily update from the institution to the vendor; or with a delivery from the institution at the time the order is placed. Similarly, Method 500 is not limited to a specific method for receiving the SIDC; the method is determined by the check printing vendor in concert with the institution. For example, the SIDC could be transmitted over a secure external network connection between the institution and the check printing vendor; or transmitted using a medium, such as a compact disc, computer diskette, or even electronic mail. Also, the institution and check printing vendor could create an automated process of delivering daily updates from the institution to the check printing vendor. This automated process would allow the check printing vendor to maintain current and valid SIDCs.

At step 504, the SIDC received from the institution is stored at the check printing vendor's repository. Step 504 is not a requirement but is a preferred embodiment because it reduces transaction time for re-orders if there have been no changes to the SIDC. If the SIDC is stored on-site, it is unnecessary for the institution to transmit the SIDC each time it or the end-user initiates a re-order. Therefore, the check printing vendor can easily obtain the SIDC from its repository system (step 506).

Steps 504 and 506 could comprise associating the SIDC with a unique indicator that identifies an order which may be the same or different from the unique identifier used between the check printing vendor and the institution. For example, the check printing vendor could store the SIDC in a file with a unique filename (e.g., unique indicator) that identifies the end-user, account and/or order; and use that filename to retrieve the SIDC. It should be appreciated, however, that a SIDC could be associated with more than one end-user. For example, if a bank account is owned by more than one end-user (e.g., husband and wife), then a check drawn from that account could legitimately be used by any of the end-users, and the SIDC would typically include more than one signature. The goal is to prevent another end-user from receiving checks with the wrong validation symbol.

Once the SIDC is obtained, it can be encrypted again (step 508) and then used to produce a validation symbol (step 510), in this example a PDF-417 barcode is used for the symbol. Step 508 is a second encryption layer process providing additional security. The secondary encryption prevents a counterfeiter from being able to produce a validation symbol that would be recognized as valid, since the signature validation engine of the invention is looking for the encrypted SIDC created at step 508 to translate and decrypt the signature.

At this stage, the data representing the encrypted SIDC could be placed in a variety of data forms or symbols. Storing the encrypted SIDC in a PDF-417 bar code as the validation symbol is preferred because of its compression advantages. For example, in situations such as checks, printing the validation symbol is limited due to both the actual size of the check surface and the portion of its “real estate” that is not already dedicated to other information, lines, or symbols that must be printed on the check. It should be appreciated, however, that the invention is not limited to PDF-417 barcodes; any symbols, any method of compression, or any storage medium may be considered.

PDF-417 is a two-dimensional (2-D) bar code that can store up to about 1,800 printable ASCII characters or 1,100 binary characters per symbol. The symbol is rectangular; the shape of the symbol can be adjusted to some extent by setting the width and allowing the height to grow with the data. It is also possible to break large amounts of data into several PDF-417 symbols which are logically linked. There is no theoretical limit on the amount of data that can be stored in a group of PDF-417 symbols. A lower density PDF-417 bar code may be printed to provide higher read rates, improve image survivability, and correspond to capabilities of the printing technology used.

PDF-417 symbols require a 2-D scanner; or a standard CCD or laser scanner and special decoding software (a wand scanner will not work). A number of scanners on the market are using both laser and CCD camera technologies.

The use of digital printing by the check printing vendor provides a more efficient means of integrating the validation symbol on the appropriate checks when compared to offset printing because it allows creation of a “virtual” plate for each check rather than multiple real printing plates, the number of which depend upon the number of fields in which information changes from check to check. It should be appreciated, nonetheless, that digital printing is not the only technique that may be used for integrating the validation symbols with a check. The PDF-417 symbology is a public domain industry standard. The features of the PDF-417 symbology include error correction and high compression efficiencies based on the data type encoded, etc. The invention employs one of the high efficiency data types to minimize the “real estate” needed on the printed document.

At step 512, the validation symbols are integrated with the check printing system. The check printing system generates the ordered checks integrated with the validation symbol (step 514). Referring back to FIG. 3, the order or re-order of the checks integrated with the validation symbol is delivered to the end-user using the established delivery process of the check printing vendor (step 610).

As stated above, SIDCs may be stored at the check printing vendor's repository system as a precursor step to creating the validation symbol 82 (FIG. 5). The method of the invention appreciates that the check printing vendor can place the SIDC and/or the resulting validation symbol in a repository to facilitate processing subsequent orders for which passing the SIDC would not be practical (e.g., phone orders, paper orders).

FIG. 5 illustrates a check 80 that has been ordered/re-ordered by an end-user or by a financial institution on behalf of the end-user. As shown, the end-user's characteristic components have been converted into validation symbols 82 illustrated as a PDF-417 barcode (using one of the techniques described above). As previously mentioned, the invention is not limited to using a bar code. Also, the validation symbol 82 can be placed at any location on the front or back of the check 80 where space is available and readable by the scanner used at the point of authentication.

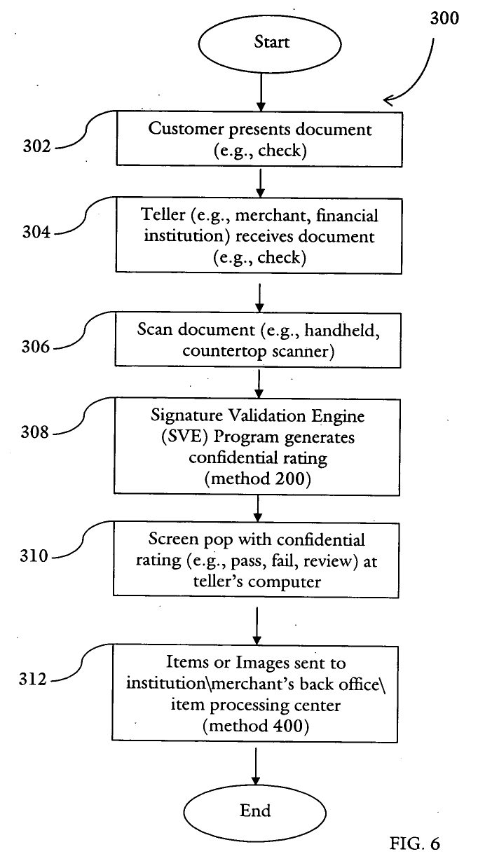

Referring now to FIGS. 6-8, an exemplary method 300 of verifying checks with an integrated validation symbol 82 at the point of presentment without connecting to a network or database is now described. It should be appreciated that method 300 is one method of authenticating a check at the point of presentment. Method 300 could begin with the presentment of a check used to make a purchase (step 302) to a sales clerk who receives the check (step 304) and scans the check using scanning technologies such as a handheld scanner or a countertop scanner (step 306).

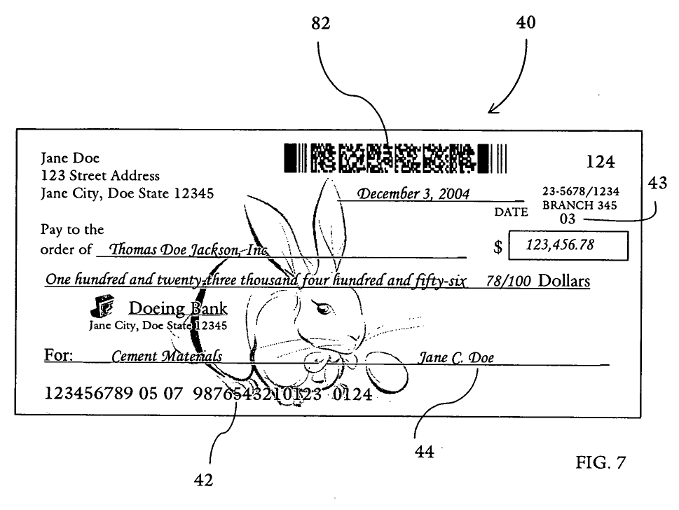

FIG. 7 illustrates an example of check 40 with validation symbol 82 (in PDF-417 bar code format) printed on the face of the check 40, where all required information such as a signature 44, a check style number 43, and an account number 42 are included on the check 40 and ready for presentment to a merchant for purchase or a financial institution for deposit.

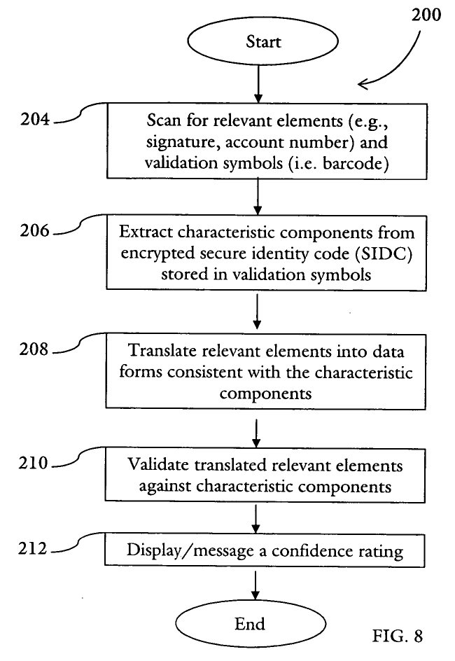

Once the check has been scanned, the resulting data is authenticated at step 308 (FIG. 6) by a system that may include a suite of device specific computer programs (referred to herein as the “signature validation engine”) and illustrated by method 200 in FIG. 8. A signature validation engine can be embedded into or accessed by various suitable devices, by platforms for validation at a point of payment or presentment, or by image capture devices. Examples of two types of devices are (1) conventional scanners found at bank teller stations or retail point of sale terminals; and (2) item processing imaging back office equipment generally found at institutions. Both types of devices, having the proper capture resolution, can be used for scanning the check and providing the image data to the signature validation engine. The signature validation engine could reside on the associated personal computer or processor.

Referring to FIGS. 7 and 8, the process for method 200 begins at step 204 by functionally directing the scanning of the check for the relevant elements such as the signature 44, the check style number 43, and the account number 42 on the check 40, for the validation symbols 82. Step 206 continues the process by extracting the characteristic components from the encrypted secure identity code stored in the validation symbols 82. At step 208, the signature validation engine translates the characteristic components from the relevant elements on the check into data forms that can be compared and evaluated against the data extracted from the validation symbols. The translation of the characteristic components from the relevant elements on the check may involve a variety of methodologies. As examples, a check style number could be read in full, while a first algorithm could be used to manipulate digits in an account number, while a second algorithm could be used to extract the characteristics of interest from the signature and condition that data in a desired fashion.

The signature validation engine rapidly compares and evaluates the translated relevant elements against the characteristic components stored in the validation symbol (step 210). A variety of gating and evaluation approaches can be applied during the process. For example, before the comparison and evaluation processes begin, if the validation symbol or any relevant element is unreadable, the signature validation engine can signal that the check is invalid. During the comparison and evaluation process, each relevant element could be considered in parallel or serially.

The signature validation engine is also capable of evaluative processing, being able to determine, for example, when more than a single signature is present, when more than a single signature is required, when alternative signatures are acceptable against the account, when more than a single check style is being used and then evaluating the data drawn from relevant elements and from the validation symbol to determine if the various combinations of data will result in an acceptable combination. The invention appreciates that validation may be tuned to achieve desired goals, such as minimizing false positives below a threshold, maintaining batch processing speeds above a threshold, and keeping false negatives below a threshold. While these competing goals are important to management, they are less relevant to a clerk, teller, or item processor who only wish to know when a check is valid, should be questioned, or rejected. The signature validation engine displays/outputs a confidence rating as to the validity of the check (step 212).

Referring again to FIG. 6, a teller could receive a pop-up on a computer screen of the confidence rating reported by the signature validation engine (step 310). The signature validation engine can report confidence ratings of each relevant element (e.g., check style confidence: 100%, Account number confidence: 100%, Signature confidence: 77.3%), but it is also capable of delivering a signal to display a desired color and statement based upon the results of its comparisons in a pass, fail or review notification. The display/outputs notifications can be colorized; for example, red can be used for failed validation (i.e. check style, account information and/or signatures that do not correspond or meet the required logic and thresholds). Yellow can be used for a marginal concern (i.e. the confidence level of correspondence of check style number, account information and/or signatures is each in a range of percentages above some floor but one or more of which are beneath some threshold for acceptance). This permits some resiliency in the process by, for example, permitting a check with a blurred MICR line or signature to not be rejected but simply present the opportunity for presentation of further identification by the presenter and personal review by the sales clerk or teller. Green can be used for signaling check approval because it passed the validation (i.e., check style number, account information and/or signatures each corresponding or meeting the required logic and thresholds).

While not necessary to the practice of the invention, the signature validation system can also provide the clerk or teller specific directions (e.g., “Request driver's license, compare names on checks and if OK, write drivers license number on check” or “Call supervisor to review check”). Likewise, while not necessary to the practice of the invention, a query function permits a clerk, teller, or other person to gain additional information concerning a yellow or red evaluation (e.g., “no check style number appears” or “account number questioned” or “insufficient number of signatures”). It should be appreciated that this invention is not limited to a specific notification method; as such, any notification method can be used.

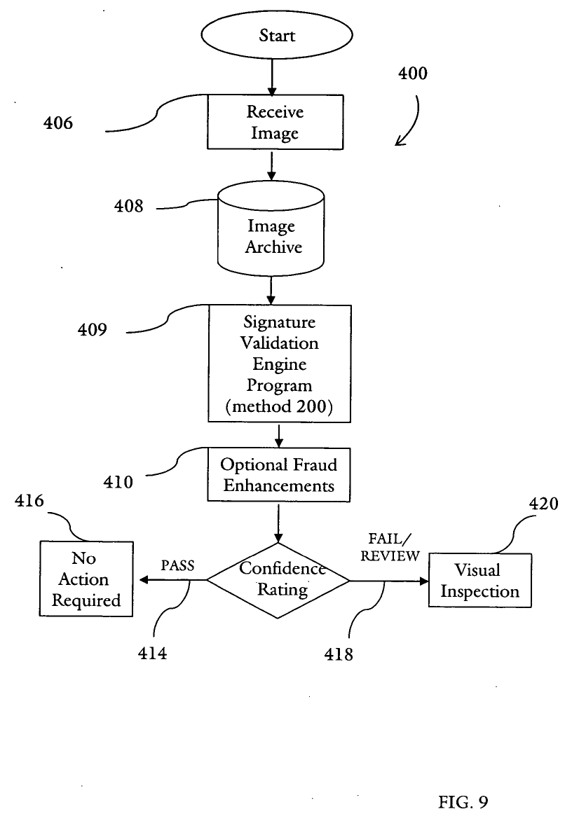

As described above, the signature validation engine method 200 is a rapid process as it can be performed on the teller's own PC, processor or scanning unit. Method 200 does not require a connection to an external network or database. As shown at step 308 (FIG. 6), the signature validation engine method 200 can be easily incorporated into an institution/merchant's check processing method, where the check could be processed by a traditional process or by an image exchange process. Another example is where the point of presentment occurs at the originating institution of the check and the images received for the image exchange process are from the teller's computer, processor or scanning device. Method 300 of FIG. 6 delivers the check itself or its image to the institution's check processing center at step 312 (where method 400 of FIG. 9 is executed).

FIG. 9 illustrates method 400, an exemplary image exchange/item processing of an institution that has adopted the signature validation engine method 200 (FIG. 8). It should be noted that FIG. 9 exemplifies one method 400 an institution may develop for processing checks. Method 400 could begin at step 406 with an institution receiving an image of a check for processing. The image could be received by an institution from more than one place. For example, it could be received from within said institution's system where the check has not been validated at the point of presentment. Also, the image could be received from another institution where the check may or may not have been validated at the point of presentment. The image is accepted into said institution's image archive 408. The check image is received from the image archive by the signature validation engine at step 409 (where method 200 of FIG. 8, as described above, is executed). As previously discussed, with respect to FIG. 8, method 200 compares and evaluates the relevant elements on a check with the characteristic components in the validation symbols on the check and displays/messages a notification (steps 204 through 212).

Referring again to FIG. 9, as an additional precautionary step, additional fraud detection techniques may be used by the institution to verify the check (step 410). If the check receives a pass/green notification (step 414) then no action may be required by the institution (step 416). If the check receives a fail/red or a review/yellow notification (step 418) then the institution may visually inspect the image to determine if the authentication-requiring document (e.g., a check) is valid (step 420). Once a check is imaged, that image can be stored in the institution's repository to be used, among other things, for later validation and for the production of banking statements. As mentioned previously, this invention can be easily adopted into an institution's existing check processing system.

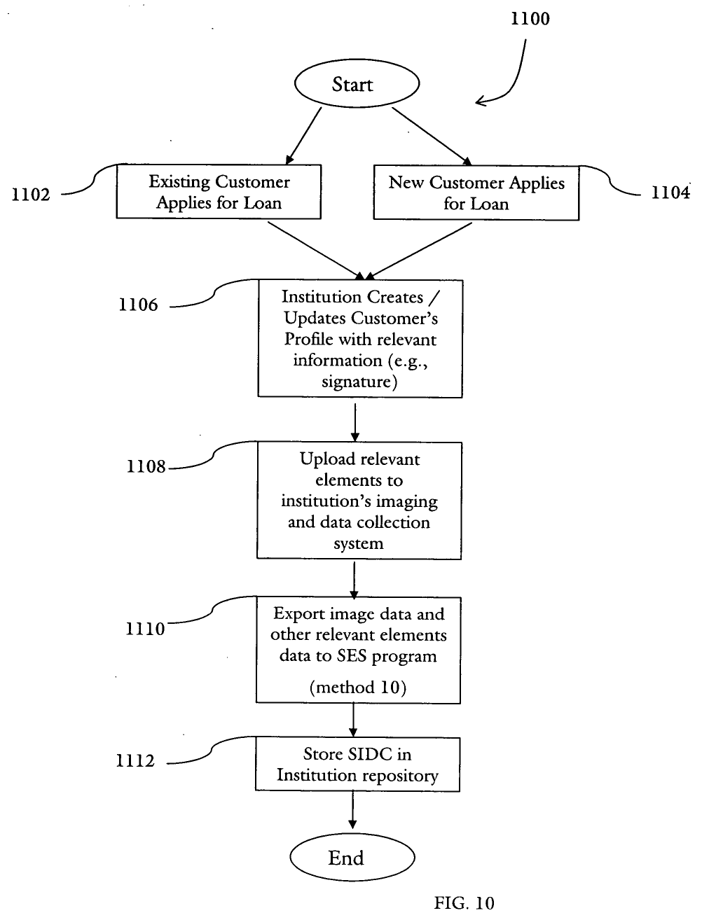

FIGS. 10-12 illustrate exemplary methods for an end-user, (e.g., an institution, individual or business) to receive a promissory note integrated with one or more validation symbols in accordance with an embodiment of the invention. In this example, promissory notes are the authentication-requiring documents. Method 1100 illustrates an institution's SIDC creation process. It should be noted that this is one example for creating the SIDC and that the illustrated method 1100 can be varied in multiple ways to allow an institution to create SIDCs in a manner convenient for the institution.

Method 1100 of FIG. 10 could begin with a new customer applying for a loan (step 1104) or by an existing customer applying for a new loan (step 1102) with an institution, such as a bank. Steps 1102 and 1104 could occur in many ways, for example, these steps could be accomplished over the Internet or by the end-user visiting the institution. Hereinafter, the customer will be referred to as the “borrower”. One primary concern for an institution in the lending process is having confidence that the borrower has executed the promissory note to secure loan repayment and making execution as convenient as possible to the borrower. In the traditional setting, this requires the borrower to either appear in person with identification at the institution's offices or before a notary public at the time of promissory note execution. The invention provides a method that avoids this process by making the note self-authenticating and consequently permitting execution by the borrower wherever she desires.

At step 1106, the institution creates or updates the borrower's profile with data that may be used as relevant elements. For example, the data for a borrower may be his signature, fingerprint, the loan amount, the loan number, street address, social security number, drivers' license number, mother's maiden name, home phone number, and business phone number. For the purposes of this example, the relevant elements for each signatory are signature, capacity, and loan number.

A promissory note often has more than a single signatory, for example business partners are all typically required to sign a loan made to their business and the institution could require one or more guarantors (e.g., individuals who would repay should the borrowers fail to repay) to execute the loan as well. The validation symbols of the invention allow for each signatory's relevant elements, comprising distinctive or common items of information to be captured for use in verification. Each necessary signatory would be agreed upon between the institution and the borrower(s) and each would visit a verification station (e.g., a bank branch having a signature encoding system), not necessarily the same one, and provide his or her relevant elements. As the relevant elements are collected for each signatory, the verification station provides the information through imaging and data entry to a signature encoding system (step 1108).

The image data and other relevant elements data are sent to the signature encoding system at step 1110 (to execute method 10 of FIG. 2). As described above, in method 10, the signature encoding system receives image and other relevant elements data from institution (step 12), collects and translates the relevant elements and data provided into characteristic components (step 14). At step 16 an SIDC is created for the signatory by encoding the characteristic components translated from the relevant elements from step 14.

Referring again to FIG. 10, once the SIDC is created, the SIDC is received by a secured method and stored in the institution's repository (step 1112). The secured transmittance method is determined by the institution. As such, the invention is not limited to one form of secured transmittance.

Once the SIDC has been stored in the institution's repository system, it can be integrated with the promissory note. Institutions currently have their own system for preparing promissory notes without the integration of the SIDC, such as when banks send requests to a loan processing center. The invention can be incorporated into the loan document production process.

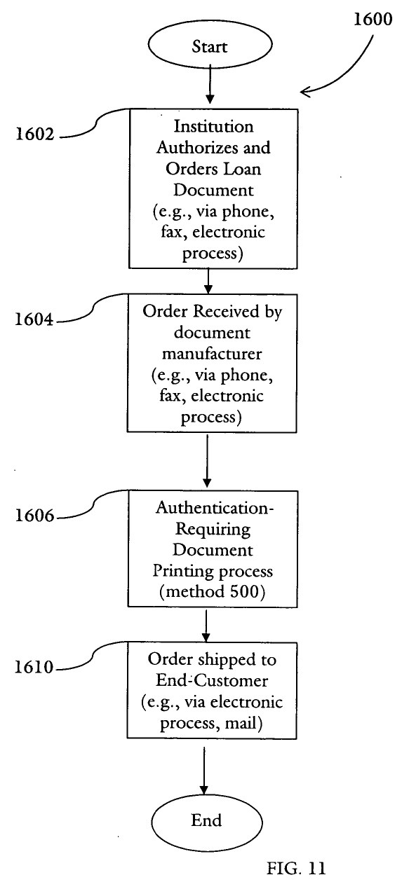

FIG. 11 illustrates one method 1600 of ordering a promissory note integrated with one or more SIDCs. Method 1600 begins by the bank authorizing the loan, requesting loan documents be prepared by the loan processing center, and advising the loan processing center of the loan details (e.g., loan number, amount, term, interest rate, borrower names, titles and addresses, guarantor names, titles and addresses) (step 1602). Step 1602 can be accomplished by many methods, such as ordering via phone, fax, in person, or an electronic process (e.g., over the Internet). The loan processing center calendars and documents the request (step 1604). The method continues at step 1606, where method 500 of FIG. 4, as described above, is executed.

As described previously, referring back to FIG. 4, method 500 generates the promissory note with the SIDCs stored in validation symbols (steps 502 through 514). Method 500 can integrate the validation symbol into the electronic version of the promissory note in the loan processing center's electronic document creation system. The document creation system generates and locks the electronic file containing both the promissory note and the data equivalent of the bar code. Referring back to FIG. 11, the locked file can then be transmitted electronically to the borrower or printed and delivered to the borrower by mail or courier (step 1610).

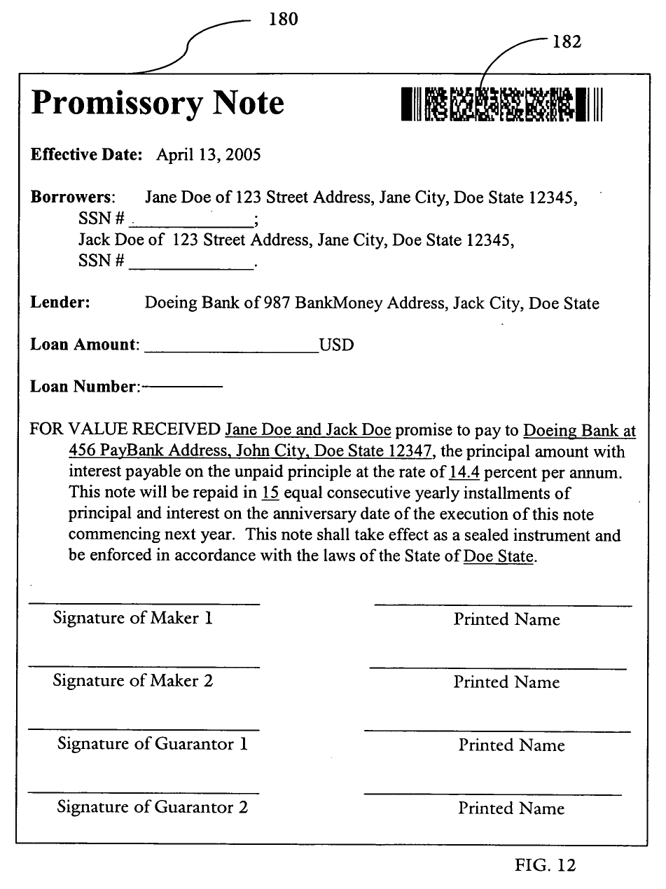

FIG. 12 illustrates a promissory note 180 that has been created as part of a loan process. As shown, the borrower's relevant elements have been converted into validation symbol 182. As previously mentioned, the invention is not limited to using a bar code. Also, the validation symbol 182 can be placed at any location on the front or back of the promissory note where space is available.

Once the borrower receives the promissory note as delivered at step 1610 of FIG. 11 from the institution, the borrower can print the promissory note if delivery at step 1610 is by electronic file transmission. Next, the borrower gathers all signatures, and mails, images or electronically transmits, the promissory note back to the institution. Provided that the borrower's imaging equipment has the proper resolution, transmission of the electronic image will not compromise either the validation symbol or the relevant elements.

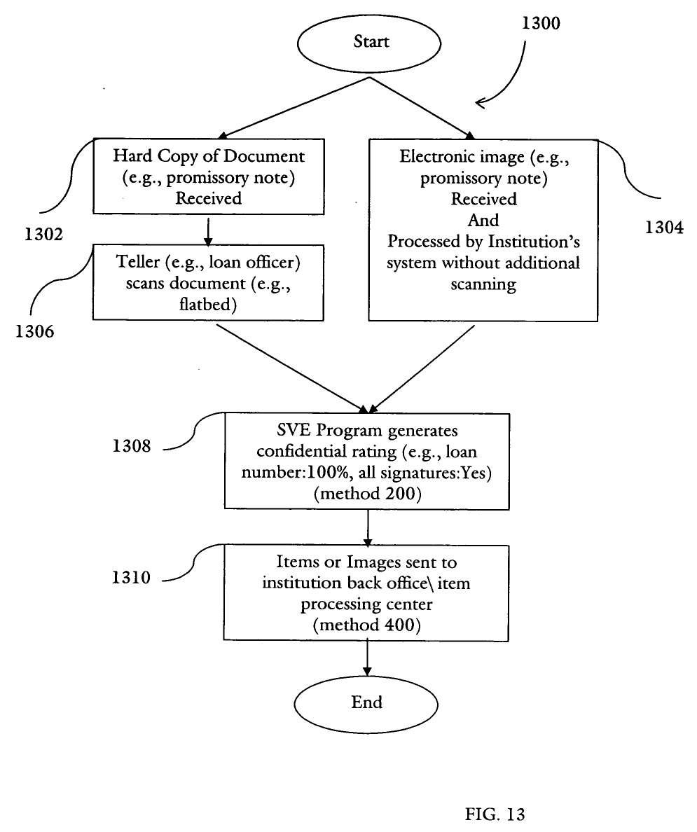

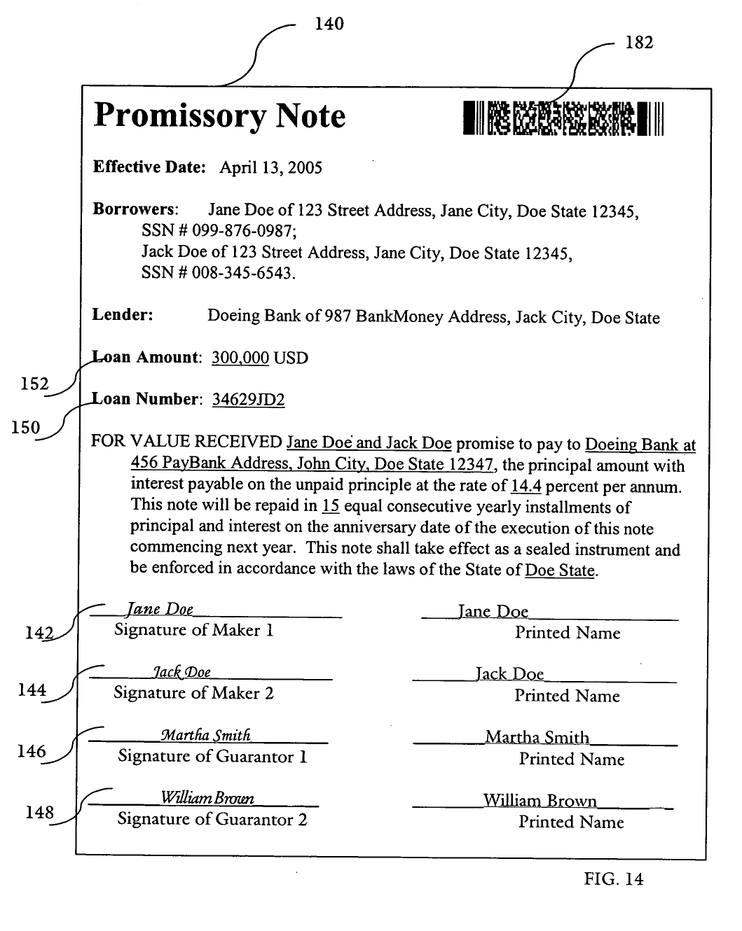

Referring now to FIGS. 13 and 14, an exemplary method 1300 of verifying a promissory note with an integrated validation symbol at the point of presentment is now described. It should be appreciated that method 1300 is one method of authenticating proper execution of the promissory note upon return to the institution. Method 1300 begins with the receipt of the fully executed promissory note from the borrower. Assuming the promissory note is returned as a hard copy original (step 1302), the institution scans the promissory note and places the original in the loan closing file (step 1306). If received as an electronic transmission, the electronic file is presented for verification without scanning (step 1304).

FIG. 14 illustrates an example of promissory note 140 with validation symbol 182 being stored in PDF-417 barcode format, where all required information such as the signatures of the borrowers 142 and 144 and the signatures of the guarantors 146 and 148 as well as the loan number 150 and the loan amount 152 are included on the promissory note 140 and ready for authentication.

Once the promissory note 140 is scanned for the relevant elements such as signatures 142, 144, 146, 148, dollar amount 152 and loan number 150; and scanned for the validation symbol 182 (FIG. 14); it is authenticated at step 1308 by method 200 as described above. A signature validation engine at method 200 can be embedded into or accessed by various suitable devices and platforms for validation at a closing office, a loan officer's desk, or the institution's back office loan processing center. For example, devices such as conventional “flat bed” scanners typical to office environments including financial institutions having the proper capture resolution can be used for scanning the promissory note and providing the image data to the signature validation engine at method 200.

Referring back to FIG. 8, method 200 rapidly compares and evaluates the translated relevant elements against the characteristic components stored in the validation symbol (steps 204 through 210). As with checks, a variety of gating and determining approaches can be used during the comparison and evaluation. Promissory note validation can be distinguished from check validation by the potential for a greater number of signatures to be present on a promissory note and the capacity in which each signature is applied. This is accommodated by the invention and although this may affect the bar code size, the available space on a promissory note is greater than that on a check and creates no problem. As described previously, method 200 displays the results of its evaluative processing (step 212). Method 200 is able to evaluate, for example, the capacity in which each signatory was expected to execute (e.g., borrower, co-signer, guarantor) and whether each such signatory has executed in such capacity. It is appreciated that at step 212 “pass/fail/review” and colorized indicators may be of less value in a loan confirmation context. Consequently the invention in this illustration reports confidence ratings as well as results and recommendations (e.g., “Amount Confidence: 100%; Loan Number: 100%; All Signatures: Yes; Signatures correct by category: Yes; Signature Confidence:Sig1-87%; Sig2-83%; Sig3-79.6%; Sig4-56%; Recommendation—ACCEPT Sigs: 1-3; QUESTION Sigs: 4”). By doing so, a loan officer is able to quickly determine if there is a problem with promissory note execution and take remedial action.

Referring back to FIG. 13, method 1300 delivers the promissory note itself or its image to its or its loan processing center's documentation repository at step 1310 (where method 400 of FIG. 9 as described previously is executed).

It must be noted that many method steps of the invention are preferably implemented as a program that gets executed on a computer or system or computerized apparatus or device. The invention can be written in different computer languages for different computer systems. The present invention can be stored on a hard drive, floppy disc, CD-ROM, DVD, or other permanent or semi-permanent computer readable storage medium. Accordingly this invention is not to be seen as limited by the foregoing description, but is only limited by the scope of the appended claims.

What is claimed as new and desired to be protected by Letters Patent of the United States is:

1. A method of authenticating a document requiring authentication, said method comprising the steps of:
scanning said document;
detecting relevant elements on said document;
detecting validation symbols on said document;
extracting encrypted secure identity code stored in the validation symbols;
extracting characteristic components from the encrypted secure identity code stored in the validation symbols, wherein said characteristic components cannot be re-created into human readable data forms corresponding to the relevant elements on said document;
translating the relevant elements on said document into data forms that correspond with the characteristic components stored in the validation symbols on said document; and
determining whether the translated relevant elements on said document correspond with the characteristic components stored in the validation symbols on said document.

2. The method of claim 1 further comprising the step of outputting a rating identifying the results of said determining step.

3. The method of claim 2, wherein said outputting step comprises displaying a predefined word used to identify a valid match.

4. The method of claim 2, wherein said outputting step comprises displaying a predefined output used to identify a valid match.

5. The method of claim 4, wherein said predefined output is a color.

6. The method of claim 2, wherein said outputting step comprises displaying a predefined symbol used to identify a valid match.

7. The method of claim 2, wherein said outputting step comprises displaying a predefined word used to identify an invalid match.

8. The method of claim 2, wherein said outputting step comprises displaying a predefined color used to identify an invalid match.

9. The method of claim 2, wherein said outputting step comprises displaying a predefined symbol used to identify an invalid match.

10. The method of claim 2, wherein said outputting step comprises displaying a predefined word used to identify an undetermined match.

11. The method of claim 2, wherein said outputting step comprises displaying a predefined color used to identify an undetermined match.

12. The method of claim 2, wherein said outputting step comprises displaying a predefined symbol used to identify an undetermined match.

13. A method of creating an authentication-requiring document, said method comprising the steps of:
collecting relevant elements from data associated with an end-user;
analyzing the collected relevant elements;
translating the relevant elements to characteristic components;
compressing the characteristic components;
encoding the compressed characteristic components into a secure identity code of approximately 100 bytes in size per end-user;
securely delivering the secure identity code to a machine readable system; and
printing an encoded version of the secure identity code on the authentication-requiring document.

14. The method of claim 13 further comprising the step of updating stored secure identity code with changes to the relevant elements of the end-user.

15. The method of claim 13, wherein said characteristic components cannot be re-created into a human readable data form corresponding to the relevant elements.

16. A method of creating and maintaining validation symbol, said method comprising the steps of:
obtaining a secure identity code;
encrypting the secure identity code; and
converting the encrypted secure identity code to validation symbols to be placed on an authentication-requiring document.

17. The method of claim 16 further comprising the step of securely delivering the validation symbol for integration with an authentication-requiring document.

18. The method of claim 16, wherein the validation symbol is stored in a computer-readable storage medium.

19. The method of claim 18, wherein the validation symbol is associated with said end-user in a computer-readable storage medium.

20. The method of claim 18 further comprising the step of updating said stored validation symbol with changes to the secure identity code associated with the end-user.

21. The method of claim 16, wherein said method further comprises integrating the validation symbol with an authentication-requiring document, wherein said validation symbol comprises approximately 100 bytes of information per end-user.

22. A computer readable storage medium containing a computer readable code for operating a computer to perform a method of authenticating a document with a validation symbol, said method comprising the steps of:
scanning said document;
detecting relevant elements on said document;
detecting validation symbols on said document;
extracting encrypted secure identity code stored in the validation symbols;
extracting characteristic components from the encrypted secure identity code stored in the validation symbols, wherein said characteristic components cannot be re-created into human readable data forms corresponding to the relevant elements on said document;
translating the relevant elements on said document into data forms that correspond with the characteristic components stored in the validation symbols on said document; and
determining whether the translated relevant elements on said document correspond with the characteristic components stored in the validation symbols on said document.

23. The method of claim 22 wherein said method further comprises the act of outputting a confidence rating identifying the results of said determining means.

24. The method of claim 23, wherein said outputting step comprises displaying a predefined word used to identify a valid match.

25. The method of claim 23, wherein said outputting step comprises displaying a predefined color used to identify a valid match.

26. The method of claim 23, wherein said outputting step comprises displaying a predefined symbol used to identify a valid match.

27. The method of claim 23, wherein said outputting step comprises displaying a predefined word used to identify an invalid match.

28. The method of claim 23, wherein said outputting step comprises displaying a predefined color used to identify an invalid match.

29. The method of claim 23, wherein said outputting step comprises displaying a predefined symbol used to identify an invalid match.

30. The method of claim 23, wherein said outputting step comprises displaying a predefined word used to identify an undetermined match.

31. The method of claim 23, wherein said outputting step comprises displaying a predefined color used to identify an undetermined match.

32. The method of claim 23, wherein said outputting step comprises displaying a predefined symbol used to identify an undetermined match.

33. A system comprising a stand alone authentication-requiring document computer program, said program causing the system to perform the steps of:
collecting relevant elements from data associated with the end-user;
analyzing the collected relevant elements;
translating the relevant elements to characteristic components;
compressing the characteristic components;
encoding the compressed characteristic components into a secure identity code of approximately 100 bytes in size per end-user;
securely delivering the secure identity code to a machine readable system; and
printing an encoded version of the secure identity code on the authentication-requiring document.

34. The system of claim 33 wherein said characteristic components cannot be recreated into a human readable data form corresponding to the relevant elements.

35. The system of claim 33 wherein said system further comprises means for updating stored secure identity code with changes to the relevant elements of the end-user.

36. A system for generating a validation symbol comprising of a stand alone capture translating computer program, said program causing the system to perform the steps of:
obtaining a secure identity code;
encrypting the secure identity code; and
converting the encrypted secure identity code to validation symbol to be placed on authentication-requiring document.

37. The system of claim 36 further comprises means for securely delivering the validation symbol for integration with an authentication-requiring document.

38. The system of claim 36, wherein the validation symbol is stored in a computer readable storage medium.

39. The system of claim 38, wherein said validation symbol is associated with said end-user in a computer readable storage medium.

40. The system of claim 38 further comprises means for updating said stored validation symbol associated with the end-user with changes to the secure identity code associated with the end-user.

41. The system of claim 36, wherein said system further comprises means for integrating validation symbol with an authentication-requiring document, wherein said validation symbol comprises approximately 100 bytes of information per end-user.

42. A method of authenticating an authentication-requiring document, said method comprising the steps of:
capturing information that will assist in authenticating the authentication-requiring document, said information including but not limited to reference data defining signatures, document details and account information;
converting the captured information into a symbol, wherein said symbol cannot be re-created into human readable form;
applying the symbol on the authentication-requiring document;
scanning the authentication-requiring document;
reading the symbol on the authentication-requiring document;
reading aspects of the authentication-requiring document appropriate for comparison with the symbol read; and
applying an automated evaluative process that will output a confidence level regarding the authenticity of the authentication-requiring document.

43. A check comprising:
a substrate; and
a validation symbol used for authentication of said check located on the substrate, said validation symbol being produced by:
collecting relevant elements from data associated with an end-user;
analyzing the collected relevant elements;
translating the relevant elements to characteristic components;
compressing the characteristic components;
encoding the compressed characteristic components into a secure identity code of approximately 100 bytes in size per end-user;
securely delivering the secure identity code to a machine readable system; and
printing an encoded version of the secure identity code on the substrate.
